(19) United States
(12) Patent Application Publication
(10) Pub. No.: US 2015/0041552 A1
(43) Pub. Date: Feb. 12, 2015

(54) THERMOSTATIC VALVE WITH A SLEEVE

(71) Applicant: VERNET, Ollainville (FR)

(72) Inventor: Thierry Maraux, Les Clayes Sous Bois (FR)

(21) Appl. No.: 14/380,352

(22) PCT Filed: Feb. 22, 2013
(86) PCT No.: PCT/EP2013/053549

§ 371 Date: Aug. 21, 2014

(30) Foreign Application Priority Data
Feb. 22, 2012 (FR) 1251613

(51) Int. Cl. G05D 23/02

(52) U.S. Cl. CPC G05D 23/022
USPC 236/101 R

(57) ABSTRACT

A thermostatic valve is for a fluid circulation circuit. The valve includes a housing through which a fluid circulates and a sleeve for regulating the circulation of the fluid. The valve also includes a thermostatic element containing a heat-expandable material and a stationary part, which are fixedly connected to the housing. The valve also includes a moving part, which commands the movement of the sleeve between its closed and open positions. A compression spring and a yoke for bearing of the compression spring are also included.

The present invention relates to a thermostatic valve for a fluid circulation circuit, in particular a coolant for a heat engine.

Valves provided with a regulating sleeve whereof the movement is controlled by a thermostatic element typically equip cooling circuits associated with high-displacement heat engines, in particular those used in trucks and certain motor vehicles, which require higher coolant flow rates for operation than those encountered for heat engines with lower displacement, for which the thermostatic valves used have gates.

In fact, using a sleeve generally makes it possible to have a so-called balanced shutter i.e., a shutter for which the difference in the pressures prevailing on either side of the wall of the sleeve is substantially zero in the direction in which the sleeve is moved by the thermostatic element, that direction in practice corresponding to the axial direction of the sleeve. Conversely, in a thermostatic valve with a gate, the latter generally extends in a plane perpendicular to the direction in which the gate is moved by the thermostatic element, such that the pressure difference prevailing on either side of the gate in that direction reaches high values, in particular when the circulation of fluid is interrupted by the gate. The energy necessary to unstick such a gate from its seat is then often significant, even more so when the flow rate of fluid to be regulated is significant and comes in the closing direction of the gate.

Valves with sleeves integrate a compressed spring that is powerful enough both to return the sleeve to the position it occupied before it was driven by a moving part of the thermostatic element, and to recall that moving part toward a stationary part of the thermostatic element, fixedly connected to the valve housing. The opposite ends of this spring can be arranged respectively bearing against a transverse bridge of the valve housing and against a force reacting part, movably connected to the sleeve, as proposed in U.S. Pat. No. 4,022,377. WO-A-2011/110783, on which the preamble of claim 1 is based, proposes that the thrust produced by that spring be supported by a rigid yoke, generally made from metal, that is fixedly connected to the housing, for example by clipping inside the tubular main wall of the housing: in fine, the housing therefore reacts the opposite forces necessary to fix the position of the yoke and necessary to fix the position of the thermostatic element, respectively. This housing thus undergoes major mechanical stresses, whereas, in particular for economic and practical reasons, it is very desirable to make that housing from plastic. The mechanical strength of the valve is limited as a result.

The aim of the present invention is to propose a thermostatic valve with a sleeve, with improved mechanical strength, even when the housing of that valve is made from plastic.

To that end, the invention relates to a thermostatic valve for a fluid circulation circuit, as defined in claim 1.

One of the ideas at the base of the invention is not to fasten the yoke to the tubular main wall of the housing, in which the fluid to be regulated by the sleeve circulates, but to seek to have that yoke react the thrust from the spring and transmit it to the housing closest to the part of the latter with which the stationary part of the thermostatic element cooperates. Thus, according to the invention, the stationary part of the thermostatic element and the yoke each cooperate, for the purposes of their respective fastening to the valve housing, with a same central seating of a bridge that extends across the tubular wall of the housing and that is fixedly connected to that tubular wall, typically while being integral with that tubular wall in the event the housing is made from plastic. Thus, the mechanical stresses generated during use by the thermostatic element and the compressed spring are essentially, or even quasi-exclusively, applied to the central seating of that bridge, having noted that advantageously, these stresses consist of compression biases of at least part of that central seating, which can therefore be absorbed without damaging the plastic material making up that central seating. In particular, even in the event the housing is made from a plastic material, the arms of the bridge, connecting its central seating to the tubular main wall of the housing, only undergo limited, or even low, forces, which makes it possible to size them to be as small as possible and thus not to significantly limit the maximum flow rate of the valve according to the invention.

Additional advantageous features of the valve according to the invention are specified in the dependent claims.

The invention will be better understood upon reading the following description, provided solely as an example and done in reference to the appended drawings, in which:

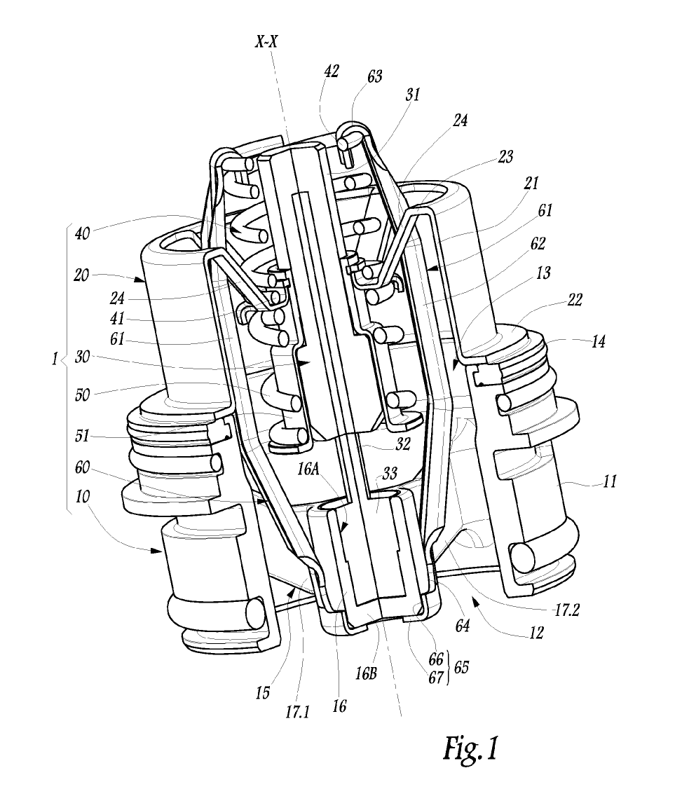

FIG. 1 is a perspective, longitudinal quarter-cross-sectional view, in which the edges of the cut parts are not crosshatched for visibility reasons, of a thermostatic valve according to the invention, the sleeve of that valve being shown in a closed position;

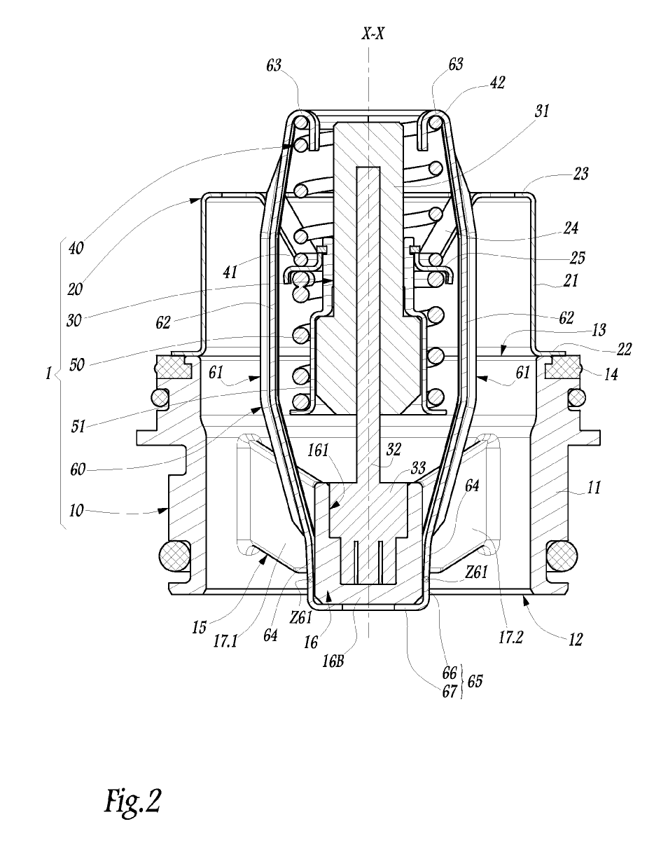

FIG. 2 is a longitudinal cross-section of the valve of FIG. 1;

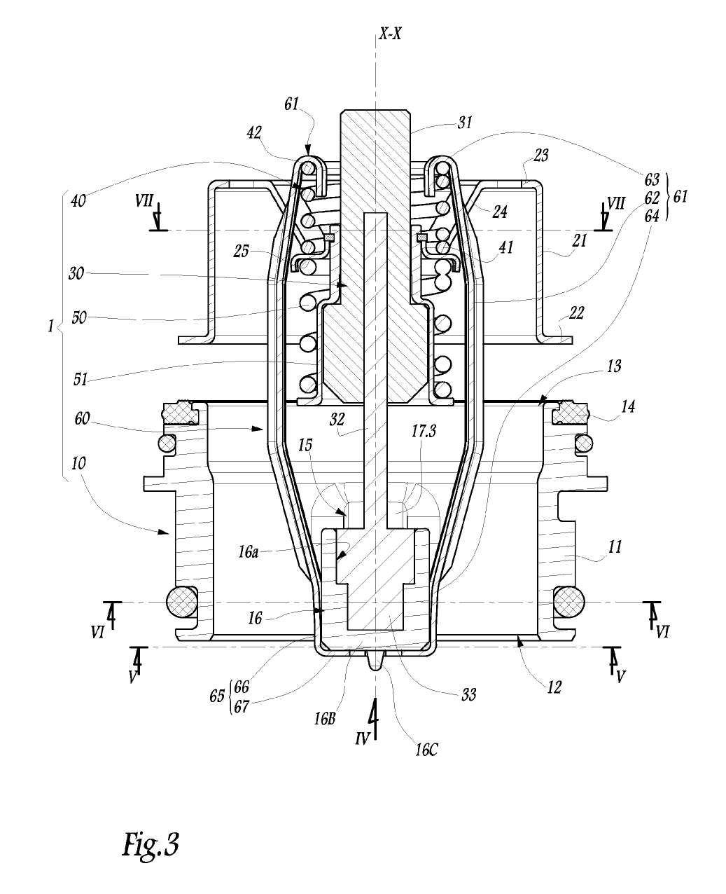

FIG. 3 is a longitudinal cross-section of the valve of FIG. 1, the cutting plane of FIG. 3 being identical to that of FIG. 2, but observed in the opposite direction, FIG. 3 showing the sleeve in an open position;

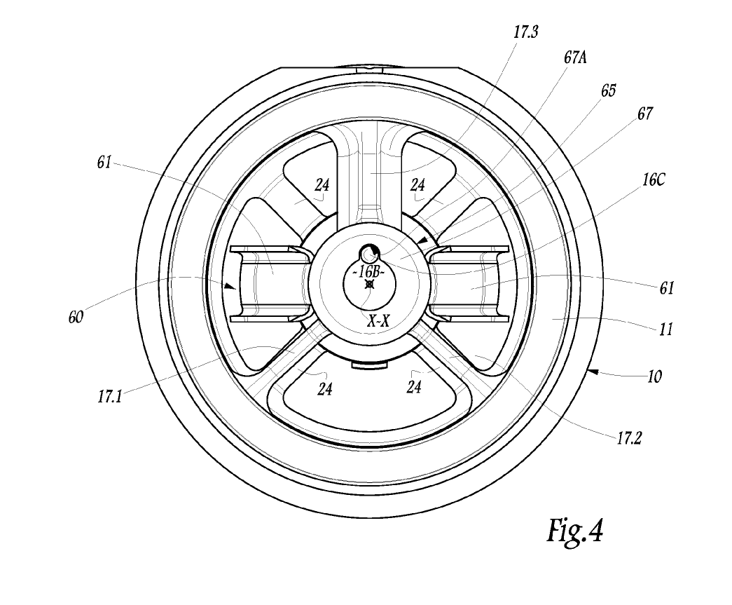

FIG. 4 is an elevation view along arrow IV in FIG. 3;

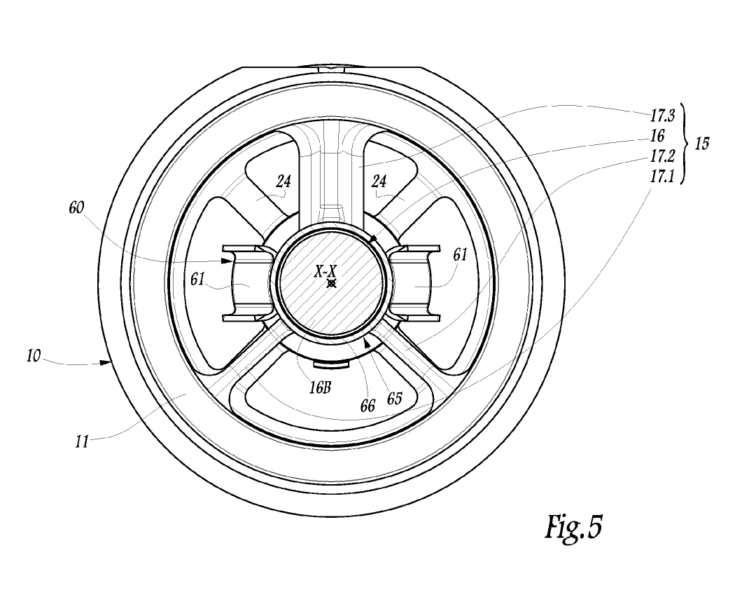

FIGS. 5, 6 and 7 are cross-sections along lines V-V, VI-VI and VII-VII, respectively, of FIG. 3; and

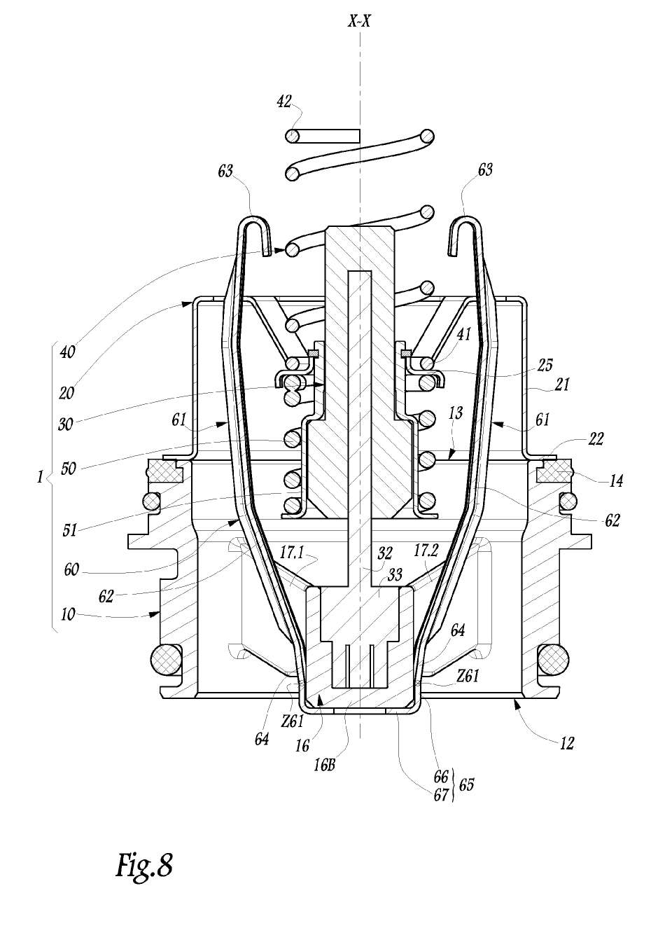

FIG. 8 is a view similar to FIG. 2, showing the valve during assembly.

FIGS. 1 to 8 show a valve 1 suitable for controlling the circulation of a fluid. The valve 1 is for example used in a cooling circuit of a heat engine of a vehicle.

The valve 1 comprises a housing 10 in particular made from a plastic material. That housing 10 includes a tubular main wall 11, which is centered on an axis X-X and which, in the example embodiment considered in the figures, has a substantially circular base, centered on the axis X-X. At its opposite axial ends, the wall 11 respectively delimits open orifices 12 and 13, between which the fluid to be regulated by the valve 1 circulates, having noted that the wall 11 is solid over its entire periphery. In practice, the fluid to be regulated can circulate from the orifice 12 toward the orifice 13, or in the other direction, depending on the assembly of the valve 1.

For convenience, the rest of the description is oriented considering that the axis X-X extends along the vertical and that the orifice 12 is oriented downward, while the orifice 13 is oriented upward.

The valve 1 also includes a sleeve 20 which, by definition, has a tubular overall shape, that tubular shape being substantially centered on the axis X-X. In the example embodiment considered in the figures, the sleeve 20 is positioned outside the housing 10, more specifically on the upper side of the tubular wall 11. The sleeve 20 includes a cylindrical main body 21, centered on the axis X-X and with a circular base, the wall of which is solid over its entire periphery. At its lower axial end, i.e., the end turned toward the tubular wall 11 of the housing 10, the body 21 is provided with an outer peripheral rim 22 designed to cooperate with the upper orifice 13 so as to regulate a flow of fluid between them: more specifically, this rim 22 is designed so as, when the sleeve is in its closed position relative to the housing 10 as shown in FIGS. 1 and 2, to bear axially, sealably against the perimeter of the orifice 13, i.e., against the upper end surface of the wall 11, so as to prevent the fluid from flowing between the rim 22 and the perimeter of the orifice 13. In other words, the perimeter of the orifice 13 forms an axial bearing seat for the rim 22, that seat being stationary relative to the housing 10. Advantageously, in the embodiment considered in the figures, the upper end of the tubular wall 11 is outwardly provided with a peripheral sealing trim 14, against which the outer part of the peripheral rim 22 bears axially, so as to seal the bearing of that rim against the perimeter of the orifice 13.

When the sleeve is in the open position relative to the housing 10, shown in FIG. 3, the rim 22 is axially separated from the perimeter of the orifice 13, such that the fluid is free to flow, in a direction globally radial to the axis X-X, between the rim 22 and the upper end surface of the wall 11, which amounts to saying that the orifice 13 is then in radial fluid communication with the outside of the sleeve 20 and the wall 11.

To command the movement of the sleeve 20, in particular between its closed and open positions described above, the valve 1 comprises a thermostatic element 30. In a known manner, the thermostatic element 30 comprises an upper cup 31, which is substantially centered on the axis X-X and which contains a heat-expandable material, not shown in the figures, such as a wax. The thermostatic element 30 also comprises a lower piston 32, which is centered on the axis X-X and which is movable relative to the cup 31 in a translational movement substantially along the axis X-X. The piston 32 is thus movable under the effect of the expansion of the heat-expandable material contained in the cup 32, the piston being deployed outside the cup when that material is heated. When the heat-expandable material cools, the piston 32 retracts inside the cup 31 under the effect of the decompression thrust from a compressed spring 40.

Advantageously, in the example embodiment considered in the figures, a heating electrical resistance, not shown in the figures, is arranged inside the piston 32, then made in the form of a heat conducting tube, such that when that resistance is supplied with electricity, it can heat the heat-expandable material contained in the cup 31. This electrical heating of the heat-expandable material completes the heating coming from the cup 31 made from a heat conducting material, that cup itself being heated by the fluid in which the cup 31 is bathed. In practice, depending on the case, these two heat sources participate in similar proportions or, on the contrary, one is negligible relative to the other, without that being limiting on the present invention. Furthermore, as one alternative that is not shown, the aforementioned electrical resistance may be missing, the cup 31 then only being thermally biased by the fluid in which it is bathed.

Returning to the description of the embodiment considered in the figures, it will be noted that the lower end of the piston 32, i.e., its end emerging from the cup 31, is secured to a head 33 that cooperates with the housing 10 for the purpose of fastening the piston 32 relative to that housing. More specifically, said head 33, the inside of which is not outlined in the figures inasmuch as the elements of the inner arrangement are not limiting on the present invention, is received in a complementary housing 16A delimited by the central seating 16 of a transverse bridge 15 with which the tubular wall 11 of the housing 10 is inwardly provided.

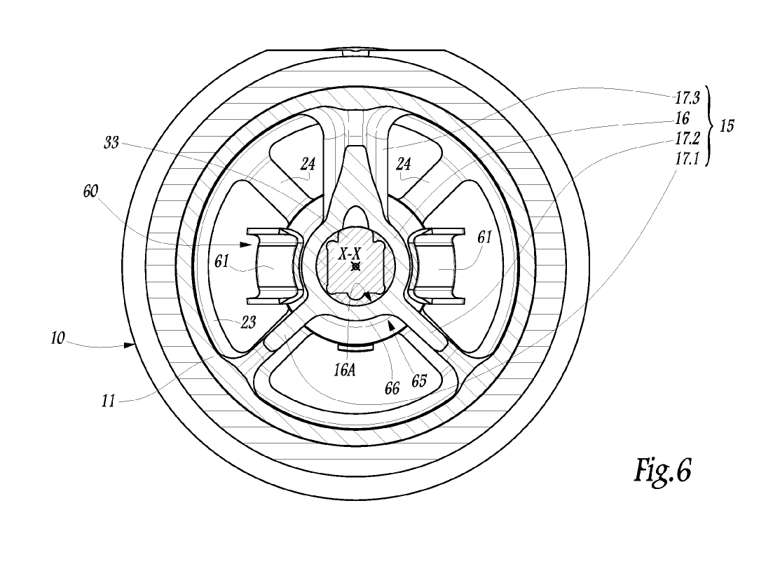

Thus, as clearly shown in FIGS. 1 to 4, the bridge 15 is fixedly arranged inside the tubular wall 11 and connects separate portions of the inner face of that wall 11 to each other, while extending protruding from those portions toward the axis X-X. In the example embodiment considered in the figures, the bridge 15 thus includes three distinct arms 17.1, 17.2 and 17.3, which are distributed substantially regularly around the axis X-X and which each extend from the inner face of the wall 11, while being integral with that wall, until they join the central seating 16, which is also integral with those arms. As shown in FIGS. 1 and 6, the central seating 16 has a globally tubular shape, which is centered on the axis X-X and which inwardly delimits the chamber 16A for receiving the head 33 of the piston 32, said chamber 16A being upwardly open, whereas it is downwardly closed by a solid bottom wall 16B, as clearly shown in FIGS. 2, 3 and 5.

It will be noted that, in the embodiment considered in the figures, the arms 17.1 to 17.3 are not identical to each other: more specifically, as clearly shown in FIGS. 4 to 6, the arms 17.1 and 17.2 are substantially identical to each other, with the exception of their angular position around the axis X-X, while the arm 17.3 is provided with a cross-section strictly larger than that of the arms 17.1 and 17.2. This is related to the fact that here, the arm 17.3 is advantageously used to contain electrical conductors, not shown in the figures, that connect the inside of the housing 16A to a base, not shown in the figures and with which the housing 10 is outwardly provided, to connect an outside electrical power source thereto. It will be understood that these electrical conductors make it possible to power the electrical resistance contained inside the piston 32 from the aforementioned electricity source, subject to the electrical connection between the terminals of that resistance and the aforementioned electrical conductors, via inner arrangement elements of the head 33, not shown in figures, as indicated above. In practice, the aforementioned electrical conductors are embedded in the plastic material making up the arm 17.3.

For reasons that will appear later, the mechanical connection between the bridge 15 of the housing 10 and the piston 32 of the thermostatic element 30, more specifically between the central seating 16 of that bridge and the head 33 of that piston, is produced at least by the fixed axial downward bearing of the head 33 against the bottom wall 16B of the seating 16, that head 33 advantageously being immobilized transversely to the axis X-X inside the housing 16A by shape adjustment. It is possible for the fixed bearing of the piston 32 against the bridge 15 not to be upwardly blocked by cooperation between that piston and that bridge. Alternatively, for example by providing a slightly forced mounting or clipping of the head 33 to the inside of the housing 16A, it is possible to retain the piston 32 axially upward relative to the bridge 15.

In light of the preceding, it will be understood that, in use, the relative movements between the cup 31 and the piston 32 of the thermostatic element 30 consist of movements of that cup relative to the housing 10 fixedly connected to the piston 32. Consequently, to control the movement of the sleeve 20 along the axis X-X, that sleeve is kinematically connected to the cup 31. A first possible approach, not illustrated by the embodiment considered in the figures, consists of providing a fixed mechanical link between the sleeve 20 and the cup 31.

One alternative, considered here, provides for inserting an overtravel spring 50 between them that has a stiffness strictly greater than that of the compression spring 40 and that is only biased when, once the sleeve 20 has been axially separated from the upper orifice 13 of the housing 10 under the driving action of the cup 31, any additional upward driving of the sleeve is made impossible, typically due to the upward axial abutment of that sleeve against a stationary obstacle. Thus, in more detail in the context of the embodiment considered here, the body 21 of the sleeve 20 is, at its upper end, provided with an inner peripheral rib 23 from which arms 24 belonging to the sleeve 20 extend rigidly toward the axis X-X. At their free end, these arms 24 are fixedly connected to each other by an annular crown 25 belonging to the sleeve and substantially coaxial to the body 21. The upper end turn of the overtravel spring 50 is axially pressed upward against the lower face of that crown 25, while the lower end turn of the overtravel spring 50 is pressed axially downward against an outer peripheral rim of a jacket 51, which outwardly surrounds the cup 31, while being fixedly connected to that cup, and around which the crown 25 is mounted freely sliding along the axis X-X, with a limitation of that sliding in the upward direction by the axial upward abutment of the crown 25 against a circlips or similar member, fastened on the outer surface of the sleeve 51. Of course, it is understood that the preceding detailed description, related to the overtravel system including the spring 50 and the jacket 51, is only an illustrative example, non-limiting with respect to the present invention, inasmuch as other overtravel assemblies that are functionally similar but structurally different can be considered.

In light of the preceding, it will be understood that, when the cup 31 of the thermostatic element 30 is translated upward along the axis X-X relative to the piston 32 under the effect of the expansion of the heat-expandable material contained by that cup, that upward translational movement is transmitted to the crown 25 and, subsequently, to the entire sleeve 20 by the overtravel spring 50, which, when the sleeve 20 is not prevented from following that translational movement, remains in a substantially unchanged state of compression: the valve 1 then goes from the configuration shown in FIG. 2 to the configuration shown in FIG. 3. In order to drive the sleeve 20 in a reverse translational movement when the heat-expandable material contracts, the lower end turn 41 of the compressed spring 40 bears axially downward against the upper face of the crown 25 of the sleeve 20 such that, under the action of a decompression thrust of the spring 40, the latter is able to recall the sleeve 20 toward the upper orifice 13 of the housing 10 and the cup 31 toward the piston 32 simultaneously. The compression of the spring 40 during the separation of the sleeve 20 relative to the housing 10, then the release of its decompression thrust to return that sleeve, are based on the fact that the upper end turn 42 of the spring 40 is axially upwardly retained relative to the housing 10, by means of a force reacting yoke 60.

This yoke 60 is made from metal or, more generally, from a material capable of withstanding the working stresses produced by the spring 40 without undergoing significant deformation. This yoke 60 comprises distinct arms 61, which are distributed substantially regularly around the axis X-X and of which there are two in the example embodiment considered in the figures, while being individually identical to one another. Each arm 61 includes an elongated running part 62 which, when the yoke 60 is in use, i.e., it is assembled to the other components of the valve 1 in a usage configuration of the valve, as in FIGS. 1 to 7, extends lengthwise substantially parallel to the axis X-X, as clearly shown in FIGS. 2 and 3. Advantageously, the running part 62 of each arm 61 has reinforcing folds, aiming in particular to reinforce the bending strength of that running part.

Toward the top, the running part 62 of each arm 61 extends by an upper end part 63 of that arm, at which the spring 40 is fixedly connected: in the example embodiment considered in the figures, this upper end part 63 advantageously has a hook shape, the recess of which is oriented downward and receives the upper end turn 42 of the spring 40, that turn 42 bearing axially upwardly against the bottom of the recess of that hook shape.

Toward the bottom, the running part 62 of each arm 61 extends by a lower end part 64 of that arm, the lower end part 64 being suitable for cooperating mechanically with the central seating 16 of the bridge 15 for the purpose of fastening the yoke 60 to the housing 10. To that end, in the embodiment considered in the figures, the two lower end parts 64 are secured to each other by a bush 65 belonging to the yoke 60 and running all around the axis X-X, each end part 64 making up a peripheral portion of the bush 65. Advantageously, the arms 61 and the bush 65 are integral, the yoke 60 being made in the form of a single-piece metal part. As clearly shown in FIGS. 1 to 5, this bush 65 comprises a tubular collar 66, centered on the axis X-X and relatively non-extended in the direction of that axis, as well as a bottom wall 67, here provided to be annular, that closes the lower end of the collar 66: the bush 65 fixedly receives the central seating 16 of the bridge 15, the outer transverse contour of that seating 16 being substantially adjusted on the inner contour of the collar 66 of the bush 65, while the lower face of the bottom wall 16B of the seating 16 bears axially downward against the bottom wall 67 of the bush 65. Thus, the yoke 60 is fastened, by its bush 65, on the central portion 16 of the bridge 15, inasmuch as the upward axial forces exerted by the compressed spring 40 on the upper end parts 63 of the arms 61 of the yoke 60 are reacted and transmitted by those arms 61 to the bush 65, which, in turn, reacts them and transmits them to the central seating 16, more specifically primarily, or even exclusively, to the bottom wall 16B of that central seating 16. Optionally, the connection between the bush 65 of the yoke 60 and the central seating 16 of the bridge 15 can be reinforced so as in particular to immobilize the latter axially relative to one another in the two opposite directions, for example by clipping.

In practice, each of the two lower end parts 64 of the arms 61 is situated, in a peripheral direction of the axis X-X, between two of the arms 17.1, 17.2 and 17.3 of the bridge 15, as clearly shown in FIG. 4, to avoid any interference between them.

Advantageously, the relative angular positioning around the axis X-X, between the central seating 16 of the bridge 15 and the yoke 60, is fixedly indexed. In the example embodiment considered in the figures, the bottom wall 16B of the seating 16 has a downward protrusion 16C to that end, not centered on the axis X-X, which cooperates by shape matching with a notch 67A delimited by the bottom wall 67 of the bush 65. Other embodiments can be considered for these angular indexing elements 16C and 67A.

During use, when the compressed spring 40 is working, the stresses that it exerts on the yoke 60 are reacted by the latter and transmitted to the central seating 16 of the bridge 15, as explained above. Thus, the central seating 16 of the bridge 15 absorbs the respective fastening stresses of the yoke 60 to the housing 10 and of the piston 32 to that housing. In other words, the thrust produced by the compressed spring 40 is reacted, via the yoke 60, as close as possible to the bearing of the piston 32: in particular, the bottom wall 16B undergoes compression between the downward axial bearing of the piston 32 and the upward axial bearing of the yoke 60, the majority, or even quasi-totality, of the forces related to the fastening to the housing 10 of the piston 32 and the yoke 60 thus being concentrated on the axially opposite faces of that bottom wall 16B. In practice, that bottom wall 16B and, more generally, the central seating 16 of the bridge 15, bears such stresses without damage even when their values are high, since by nature, the plastic material making up that bottom wall 16B has a high level of compressive strength. Furthermore, by thereby concentrating the fastening forces to the housing 10 on the central seating 16, the rest of the bridge 15, in particular the arms 17.1, 17.2 and 17.3, are only subjected to limited forces during the work of the thermostatic element 30 and the work of the compressed spring 40.

Regarding the last aspect mentioned just above, it will be noted that, according to one advantageous embodiment, the spring 40 is assembled to the other components of the valve 1 in a compressed state, i.e., with an axial length strictly smaller than that which the spring occupies when idle: in this way, the spring 40 continuously produces a decompression thrust along the axis X-X, which tends both to keep the yoke 60 upwardly bearing against the central seating 16 of the bridge 15 and to keep the piston 32 downwardly bearing against that same seating 16. It will be understood that it is then not necessary to permanently fixedly secure the yoke and the piston to the bridge. Furthermore, by providing that the spring 40 is thus assembled in compression while the valve 1 is in the operating configuration of FIGS. 1 and 2, i.e., when the sleeve 3 closes the perimeter of the upper orifice 13 of the housing 10, the spring 40 applies its decompression thrust on the sleeve 20 so as to keep it pressed under load against the perimeter of the upper orifice 13, which reinforces the sealing of the bearing of the sleeve against that perimeter.

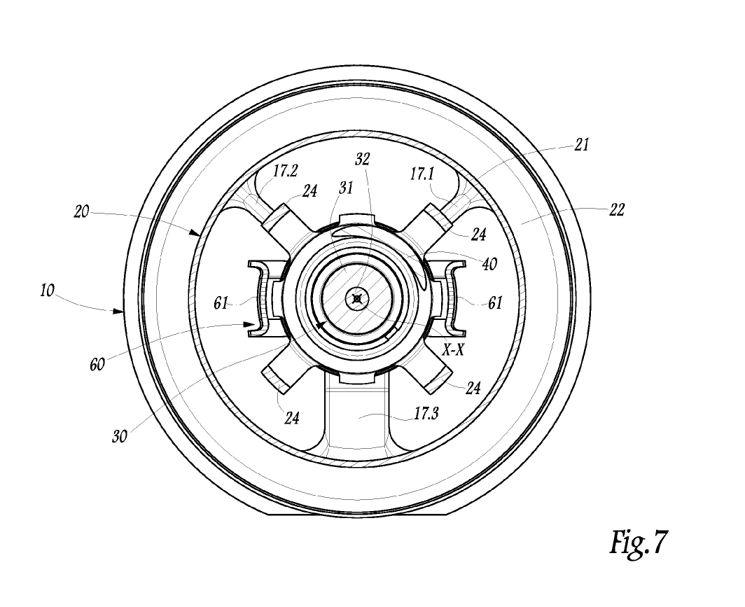

Furthermore, in the embodiment considered in the figures, the upper axial end of the body 21 of the sleeve 20 is not closed. On the contrary, fluid may flow axially between the inside and the outside of the sleeve 20, through the upper end of its body 21: that fluid then flows, in a direction peripheral to the axis X-X, between the arms 24. Thus, it will be understood that the valve 1 considered in the figures is preferably intended to regulate fluid between three paths, i.e., between one incoming path and two outgoing paths, or between two incoming paths and one outgoing path, a first of the three paths being in axial fluid communication with the inner orifice 12, the second of those three paths being in axial fluid communication with the upper end of the body 21 of the sleeve 20, and the third path being in radial fluid communication, with interposition of the body 21 of the sleeve 20, with the upper orifice 13 of the housing 10. In this context, it will be noted that in the embodiment considered in the figures, the cup 31 of the thermostatic element 30 extends axially upward past the upper end of the body 21 of the sleeve 20, at least when that sleeve is in its closed configuration of FIGS. 1 and 2. Likewise, the compressed spring 40 extends axially upward past the upper end of the body 21 of the sleeve 20, at least when that sleeve is in the closing configuration of FIGS. 1 and 2: in particular, the upper end turn 42 of the spring 40 is situated at an axial level situated above the upper end of the body 21 of the sleeve 20, at least when that sleeve is in its closed configuration, as clearly shown in FIG. 2, such that the arms 61 extend upward past that end of the body 21 of the sleeve 20. To that end, as clearly shown in FIG. 7, each of the arms 61 passes, in a direction peripheral to the axis X-X, between two of the arms 24 of the sleeve 20.

FIG. 8 illustrates an advantageous optional arrangement of the yoke 60, facilitating the assembly of the valve 1, i.e., at its lower end part 64, each arm 61 is connected to the bush 65 deformably between its usage position, shown in FIGS. 1 to 7, and an assembly position, shown in FIG. 8. To go between these two positions, each arm 61 is moved relative to the bush 65 by tilting around a geometric axis Z61 extending at the lower end part 64 in a direction substantially orthoradial to the axis X-X, as indicated in FIGS. 2 and 8. Thus, in its assembly position shown in FIG. 8, each arm 61 is inclined relative to the axis X-X, moving upward away from that axis, with the result that the radial distance between the upper end part 63 of the arm and the axis X-X is strictly larger than the radius of the upper end turn 42 of the spring 40: in that position, the upper end parts 63 of the arms 61 are each far enough away from the axis X-X to allow the downward axial insertion, without interference, of at least the spring 40, as well as the overtravel spring 50 and the jacket 51 if applicable, as well as, potentially, the cup 31 and the piston of the thermostatic element 30. Once the lower end turn 41 of the spring 40 is pressed against the crown 25 of the sleeve 20, the downward insertion movement is continued, so as to compress the spring 40, until its upper end turn 42 is axially positioned below the axial level of the upper end parts 63 of the arms 61. While keeping the spring 40 in that compressed state, the arms 61 are then tilted inward, i.e., toward the axis X-X, around their tilting axis Z61: the upper end parts 63 of the arms 61 are thus each brought closer to the axis X-X, until those upper end parts are positioned axially overhanging the upper end turn 42, the arms 61 then extending substantially parallel to the axis X-X. The spring 40 is then released and partially decompresses, until its upper end turn 42 bears upwardly against the upper end parts 63 of the arms 61.

In practice, the yoke 60 is manufactured, in particular by stamping, in an initial configuration in which those arms 61 can be either in their assembly position of FIG. 8, or in their usage position of FIGS. 1 to 7, or in an intermediate position between the two aforementioned positions, with the understanding that, during the assembly of the valve 1, an ad hoc tooling makes it possible, depending on the case, to separate the upper end parts 63 of the arms 61 from the axis X-X or bring them closer thereto, by tilting thereof around respective axes Z61.

As an alternative that is not shown, the functional arrangement of the upper 63 and lower 64 end parts of each arm 61 may be reversed with respect to the central seating 16 of the bridge 15 and the turn 42 of the spring 40: in that case, the lower end part of each arm is free, while being able to cooperate with the central seating 16 for the purpose of fastening the yoke 60 to the housing 10, while the respective upper end parts of the arms are secured by a corresponding part of the yoke 60, such as the bush 65 for the lower end part 64 in the embodiment shown in the figures, so as both to cooperate with the turn 42 of the spring 40, so as to react the thrust produced by the compressed spring 40, and to connect the arm to that corresponding part of the yoke deformably between a usage position and an assembly position, similar to that described with respect to FIGS. 1 to 7 and that described with respect to FIG. 8, respectively.

Lastly, various arrangements and alternatives to the valve 1 described thus far may be considered. For example:
the geometry of the housing 10 may be modified relative to that considered in the figures, in particular to adapt to the implantation environment of the valve 1;
the shape and number of the arms 17.1 to 17.3 and/or the arms 24 and/or the arms 61 are not limited to those shown in figures; and/or
as an alternative that is not shown, the sleeve 20 can be completely closed at the upper end of its body 21, the valve 1 then preferably being designed to regulate the flow between only two fluid paths, i.e., one incoming path and one outgoing path; of course, in that case, unlike the embodiment shown in the figures, it is preferable for none of the components of the valve to pass axially through the wall closing the upper end of the body 21 of the sleeve 20, for example subject to appropriate axial sizing of that body 21.

1. A thermostatic valve (1) for a fluid circulation circuit, comprising:
a housing through which a fluid circulates,
a sleeve for regulating the circulation of the fluid through the housing, said sleeve being substantially centered on an axis along which the sleeve is movable relative to the housing between a closed position, in which the sleeve cuts a flow of fluid, and an open position, in which that flow of fluid is allowed,
a thermostatic element, containing a heat-expandable material and comprising a stationary part, which is fixedly connected to the housing, and a moving part, which is movable along the axis relative to the stationary part under the effect of an expansion of the heat-expandable material and which is kinematically connected to the sleeve so as to command the movement of the sleeve between its closed and open positions,
a compression spring to recall the stationary and moving parts of the thermostatic element toward one another, and
a yoke for bearing of the compression spring which, during use, is fixedly connected to the housing and supports the decompression thrust produced by the compression spring, wherein
the housing is inwardly provided with a transverse bridge including a central seating that cooperates both with the stationary part of the thermostatic element to connect the stationary part fixedly to the housing, and with the yoke to connect the yoke fixedly to the housing.

2. The valve according to claim 1, wherein the central seating of the bridge is at least partially axially inserted between the yoke and the stationary part of the thermostatic element.

3. The valve according to claim 1, wherein the central seating of the bridge includes a wall having axially opposite faces against which bear, respectively, the yoke under the effect of the thrust produced by the compression spring and the stationary part of the thermostatic element under the effect of the expansion of the heat-expandable material.

4. The valve according to claim 1, wherein the yoke includes arms distributed around the axis, each arm having two end parts, which are opposite one another in the longitudinal direction of the arm and which, in use, cooperate with the central seating of the bridge in order to be fastened to the housing and with an end of the compression spring in order to react the thrust produced by the compression spring, respectively.

5. The valve according to claim 4, wherein a first of the two end parts of each arm is free with respect to the rest of the yoke, while the second end parts of the arms are secured to each other by a corresponding part of the yoke,
and in that, at its second end part, each arm is connected to said corresponding part of the yoke deformably between a usage position, in which the first end part of the arm is positioned overhanging the end of the comporession spring in the decompression direction of the spring, and an assembly position, in which the first end part is separated, moving away from the axis, from the place that it the first end part occupies when the arm is in its usage position.

6. The valve according to claim 5, wherein the arms and said corresponding part of the yoke are integral.

7. The valve according to claim 6, wherein the yoke is made in the form of a single-piece metal part.

8. The valve according to any one of claims 5 to 7, characterized in that each arm is movable between its assembly and usage positions by tilting around an axis substantially orthoradial to the axis.

9. The valve according to claim 5, wherein, in their useage position, the arms extend substantially parallel to the axis.

10. The valve according to claim 5, wherein the first end part of each arm has a hook shape having a recess that is suitable for receiving an end turn of the compression spring, which bears against the bottom of that recess under the effect of the thrust produced by the compression spring.

11. The valve according to claim 1, wherein the yoke is provided with an indexing element, for angularly indexing the yoke around the axis, said indexing element being suitable for cooperating with an associated element with which the central seating of the bridge is provided.

12. The valve according to claim 11, wherein the indexing element cooperates with the associated element by shape matching.

13. The valve according to claim 1, wherein the housing is made from a plastic material.
